(19) United States
(12) Patent Application Publication
(10) Pub. No.: US 2010/0205972 A1
(43) Pub. Date: Aug. 19, 2010

(54) ONE-PIECE CAN COMBUSTOR WITH HEAT TRANSFER SURFACE ENHACEMENTS

(75) Inventors: Ronald James Chila, Greer, SC (US); Ronald Scott Bunker, Niskayuna, NY (US); Kevin Weston McMahan, Greer, SC (US); Jonathan Dwight Berry, Simpsonville, SC (US)

Correspondence Address: SUTHERLAND ASBILL & BRENNAN LLP, 999 PEACHTREE STREET, N.E., ATLANTA, GA, 30309, US

(73) Assignee: GENERAL ELECTRIC COMPANY, Schenectady, NY (US)

(21) Appl. No.: 12/372,246

(22) Filed: Feb. 17, 2009

(51) Int. Cl. F02C 7/12

(52) U.S. Cl. 60/752; 415/177

(57) ABSTRACT

A method, system, and apparatus is provided for transferring heat from a can combustor associated with a gas turbine by providing a one-piece can combustor body having surface features that facilitate the transfer of heat away from the can combustor body, and by directing air flow to the surface features so that heat from the can combustor body is transferred from the surface features to the air flow.

### FIELD OF THE INVENTION

This invention relates generally to turbine components, and more particularly to a one-piece can combustor with heat transfer surface enhancements.

### BACKGROUND OF THE INVENTION

Industrial gas turbines are typically designed with one or more combustion chambers, also known as “combustors” or “cans”, often arranged in a circular array around the circumference of the turbine. In some turbines, air and fuel streams are pre-mixed before entering the combustors, and in others, the air and fuel is mixed together within the combustor. After ignition of the fuel mixture, the hot combustion gases exit the combustor and the resulting forces act to turn the turbine, where the rotational energy may be utilized, for example, to generate electricity via a generator.

The process of burning the air and fuel mixture can produce flame temperatures in excess of about 3900 degrees Fahrenheit, but the conventional combustors, associated liners and transition pieces, having metallic walls, are generally capable of withstanding temperatures of only about 1500 degrees Fahrenheit for a limited amount of time, typically about 10,000 hours, before the metallic pieces need to be replaced. One approach for reducing the temperature of the flame is to pre-mix the fuel and compressed air. Such an approach is driven primarily by the requirement to reduce NOx emissions, but even though the resulting lean, premixed combustion produces cooler flame temperatures and reduced NOx emissions, the flame temperature is still too hot for the conventional combustor components to withstand. Therefore, steps must taken to cool the combustor, liner, and transition pieces.

Various methods have been proposed for cooling the combustor and associated components. One cooling method, generally associated with conventional combustors, is to surround the outside of the combustor with a flow sleeve, and to introduce relatively cool, compressed air from the flow channel between the liner and flow sleeve through holes in the liner and into the hot combustion gas stream. The film of air passing over the hot surface can reduce the heat flux to the components, and, therefore, this type of cooling is sometimes referred to as “film-cooling”. In pre-mixed, low NOx emission systems, however, the amount of cooling air available may be limited, and alternate methods, including “backside” cooling have been proposed to cool the combustor, liner, and associated components.

Backside cooling involves passing compressed discharge air over the outer surface of the combustor liner before premixing the air with fuel. Much of the patent literature has focused on various liner modifications and embodiments to enhance the cooling. For example, “turbulators” of various shapes and sizes, placed on the outside of the liner, have been proposed for enhancing heat transfer (see, for example, U.S. Pat. Nos. 7,104,067; 6,681,578; and 6,098,397). The various known techniques for enhancing heat transfer work with varying efficiencies, and each technique has an impact on thermal gradients and pressure loss.

The cost of producing, assembling, maintaining, and rebuilding turbine combustors is directly related to the number of parts required for building the combustors. U.S. Pat. No. 7,082,766 introduced the concept eliminating transition, or flow sleeve, pieces from the combustor head-end, and transitioning to the turbine annulus sector with a single transition piece formed from two halves or several components welded together. There still remains, however, the need for enhanced combustor cooling with minimal associated machining, welding, etc, that may be required, for example, to assemble the combustor, or to define turbulators and/or heat removal enhancements on the surface of the combustor parts.

### BRIEF SUMMARY OF THE INVENTION

Some or all of the above needs can be addressed by certain embodiments of the invention. According to an example embodiment of the invention, a method is provided for transferring heat from a can combustor associated with a gas turbine. The method includes providing a one-piece can combustor body having at least one surface feature operable to transfer heat away from the can combustor body and directing air flow adjacent to the at least one surface feature. Heat from the can combustor body is transferred through the at least one surface feature to the air flow.

According to an example embodiment of the invention, a system is provided for transferring heat from a can combustor associated with a gas turbine. The system includes a one-piece can combustor body having at least one surface feature operable to transfer heat away from the can combustor body, and a sleeve for directing air flow adjacent to the at least one surface feature. Heat from the can combustor body is transferred through the at least one surface feature to the air flow.

According to an example embodiment of the invention, an apparatus is provided for dissipating heat from a can combustor associated with a gas turbine. The apparatus includes at least one surface pattern associated with the can combustor body and operable to transfer heat away from the can combustor body when an air flow is directed adjacent to the at least one surface feature.

### BRIEF DESCRIPTION OF THE FIGURES

Reference will now be made to the accompanying drawings, which are not necessarily drawn to scale, and wherein:

FIG. 1 illustrates an example turbine including a one-piece can combustor according to an embodiment of the invention.

FIG. 2 is a perspective view of an example one-piece can combustor with surface enhancements, according to an example embodiment of the invention.

FIG. 3A illustrates an example chevron pattern for the surface enhancements of FIG. 2, according to an example embodiment of the invention.

FIG. 3B illustrates a close-up view of a chevron features, for the surface enhancements of FIG. 2, according to an example embodiment of the invention.

FIG. 3C illustrates an example dimple or bump pattern for the surface enhancements of FIG. 2, according to an example embodiment of the invention.

FIG. 3D illustrates an example mesa pattern for the surface enhancements of FIG. 2, according to an example embodiment of the invention.

FIG. 3E illustrates an example fin pattern for the surface enhancements of FIG. 2, according to an example embodiment of the invention.

FIG. 3F illustrates an example sand dune pattern for the surface enhancements of FIG. 2, according to an example embodiment of the invention.

FIG. 4 depicts example measurement data showing friction multipliers for various surface enhancement embodiments, according to example embodiments of the invention.

FIG. 5 depicts an example method flowchart for removing heat from a can combustor, according to an example embodiment of the invention.

### DETAILED DESCRIPTION OF THE INVENTION

Embodiments of the invention will be described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

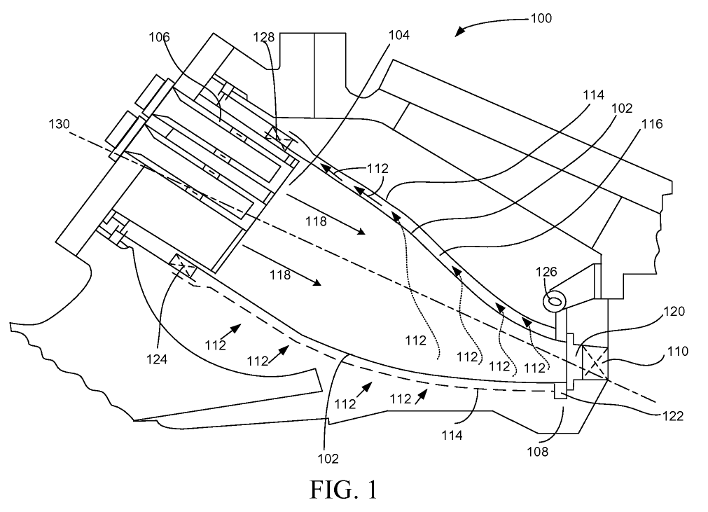

An example can combustor 100 section of a gas turbine is illustrated in FIG. 1, according to an embodiment of the invention. The combustor 100 in FIG. 1 depicts a one-piece can combustor 102, having a head end 104 near a plurality of fuel nozzles 106, and an aft end 108 near the first stage of the turbine 110. During operation, discharge air 112 compressed to a pressure of approximately 200-400 p.s.i. may impinge upon, and flow through a plurality of holes in an impingement sleeve 114 and into a cooling annulus 116 where the discharge air 112 may remove heat from the one-piece can combustor 102. A given section of the cooling annulus 116 perpendicular to the center axis 130 may or may not be representative of a true geometrical annulus, but may be circular, oval, square or any combination of shapes as needed. The discharge air 112, may swirl around the circumference of the one-piece can combustor 102 within the cooling annulus 116 where it may be directed back towards the head end 104 and may be mixed with fuel in the fuel nozzles 106. The fuel/air mixture 118 may then travel towards the aft end 108 of the one-piece combustor 102 where, after being ignited, may exit at the turbine annulus sector 120 and drive the first stage of the turbine 110.

According to an example embodiment of the invention, the cap seal interface 128 of the one-piece can combustor 102 may attach to the frame of the can combustor 100 at the head end 104 via radial struts 124. The aft end 108 of the one-piece can combustor 102 may be secured to the frame of the can combustor 100 by attaching the aft frame 122 to a bracket assembly 126.

Again with reference to FIG. 1, the discharge air 112 may flow around the one-piece can combustor 102 within the cooling annulus 116, and may, by convective cooling, remove a portion of the heat from some or all of the surrounding structures. However, according to an embodiment of the invention, the heat transfer coefficient may be increased by manufacturing the one-piece can combustor 102 with surface enhancements to (a) provide additional surface area for which the discharge air 112 may interact with the one-piece can combustor 102, and to (b) impart multiple local flow disruptions (or turbulence) at the air-surface boundary for increasing the interaction of the air with the surface, and thereby, removing more heat from the surrounding structure. According to embodiments of the invention, the discharge air 112 may be directed to flow in any direction, including perpendicular and parallel, with respect to the normal of the surface and/or surface enhancements. According to other embodiments of the invention, the discharge air 112 may naturally flow in any direction, including perpendicular and parallel, with respect to the normal of the surface and/or surface enhancements. Discharge air 112, flowing adjacent to the surface enhancements, may also flow adjacent to the surrounding structures and surfaces, thereby, transferring heat from all adjacent surfaces.

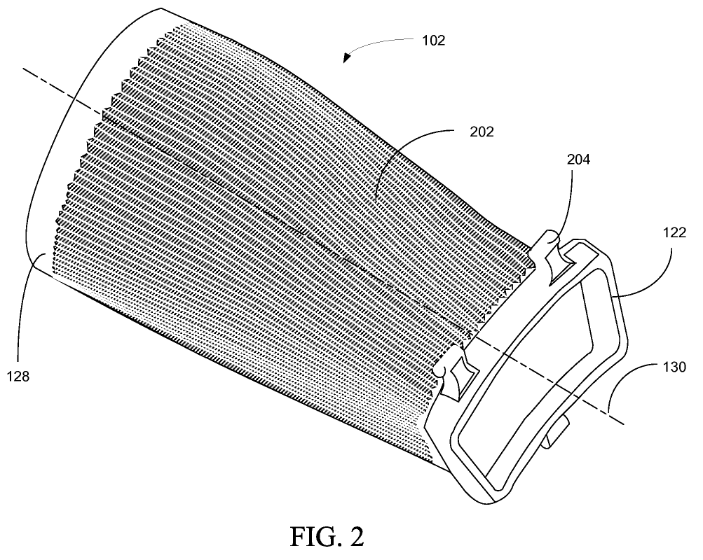

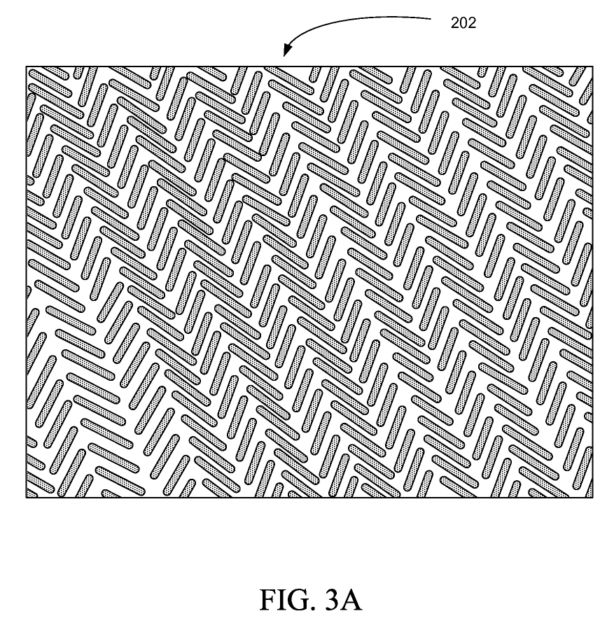

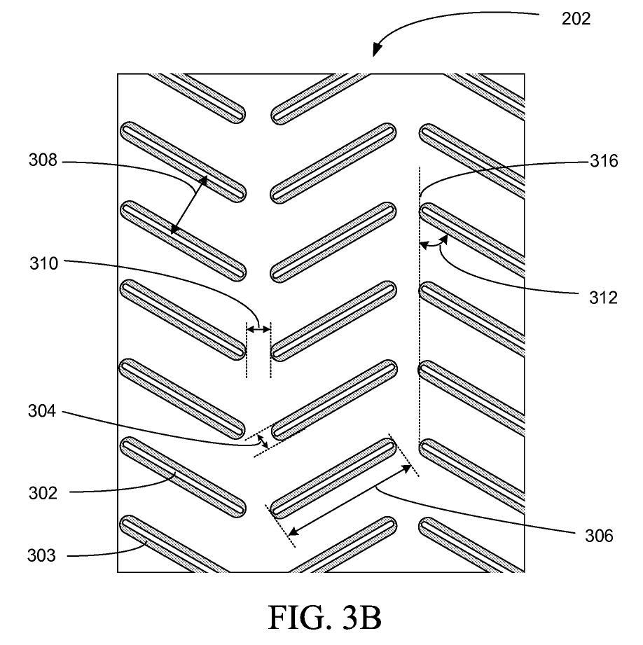

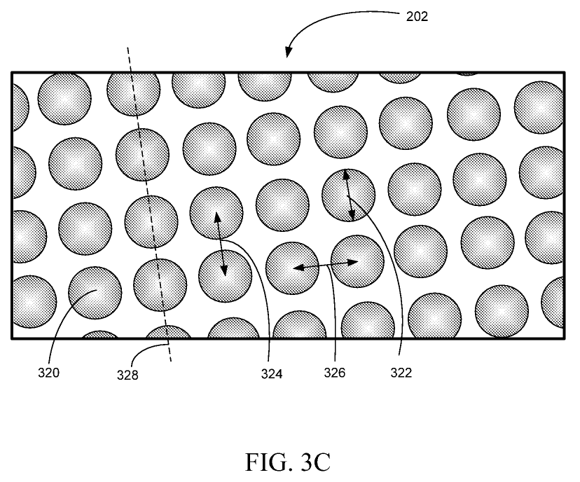

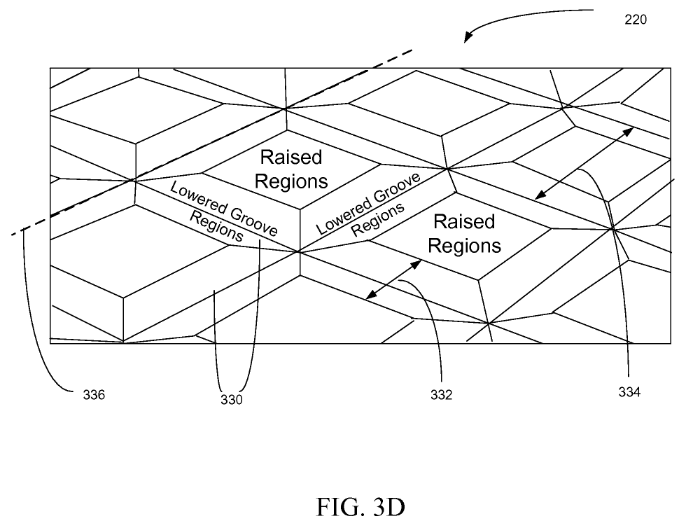

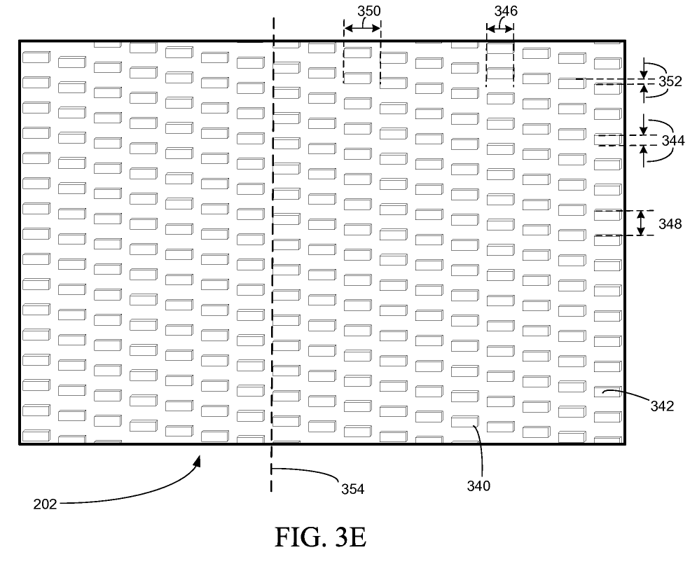

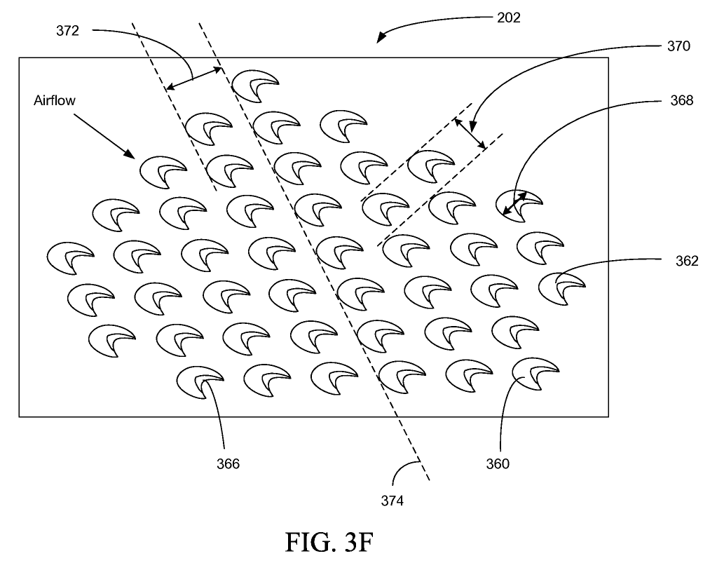

FIG. 2 depicts an example one-piece can combustor 102 with example surface features 202 in accordance with an embodiment of the invention. Also shown is an example embodiment of the aft frame 122, and the cap seal interface 128. According to an embodiment of the invention, the entire body of the one-piece can combustor 102, including the surface features 202, cap seal interface 128, and aft frame 122 may be cast as a unitary body. Different example embodiments of the surface enhancements will be shown in FIGS. 3A-F below. According to other example embodiments of the invention, the one-piece can combustor 102 may include additional or less mounting frames, brackets, and surface features without departing from the scope of the invention.

According to an example embodiment of the invention, and as depicted in FIGS. 1 and 2, the one-piece can combustor 102 may have a generally circular or oval opening at the head end 104, and may transition to a generally rectangular and reduced cross-sectional area at the aft end 108. The body of the one-piece can combustor 102 may have a non-symmetrical curvature extending from the aft end 108 to the head end 104 to allow multiple combustors to drive a single turbine while fitting within certain spatial confines of a multiple can combustor system.

Example embodiments of certain example surface enhancements for a one-piece can combustor, such as 102 in FIG. 1, will now be discussed with reference to FIGS. 1-3. FIG. 3A depicts an example surface feature 202 comprising a plurality of segmented and angled turbulators, or ribs, in the pattern of a chevron array. FIG. 3B depicts a detailed view of the surface feature 202 shown in FIG. 3A. According to an example embodiment of the invention, a surface feature 202 can comprise one or more elements, or ribs, cast in the one-piece can combustor 102, and which may be approximately 0.5 mm to 1.0 mm in height, and further, may have either a substantially flat or rounded rib top 302 surface. The ribs may also transition from the flat, lower regions, to the rib top 302 with a transition radius 303 approximately equal to the height of the rib. The width 304 of the surface feature 202 ribs may be approximately 0.5 mm to 1.0 mm, and the length 306 may be approximately 0.5 to 1.5 cm. The rib row separation 308 may be approximately 5 to 15 mm. The rib end separation 310 from the ends of the ribs in one row to the ends of the ribs in the adjacent row may be approximately 1 to 5 mm. The surface feature 202 ribs may form an angle 312 of about 0 to about 90 degrees with respect to the row line 316, however in one embodiment, the angle 312 is approximately 65 degrees. The surface enhancement row line 316 may run generally parallel to the center axis 130 of the one-piece can combustor 102, or the row line 314 may be set at an angle, for instance, between about 0 and about 45 degrees with respect to the center axis 130. Since the diameter of the one-piece can combustor 102 varies from the head end 104 to the aft end 108, it will be appreciated that the length 306 or the end separation 310 of individual elements of the surface feature 202 may vary as a function of the position along the body of the one-piece can combustor 102.

FIG. 3C depicts another example surface feature 202 comprising an array of dimples or concavities 320 cast within the one-piece can combustor 102 according to another embodiment of the invention. In this embodiment, the concavities 320 may have a diameter (D) 322 between about 7 to about 13 mm, a depth (A) between about 0.25 to about 0.5 mm, center to center row spacing (Sr) 324 between about 11 to about 20 mm, and center to center column spacing (Sc) 326 between about 11 to about 20 mm. According to an example embodiment of the invention, the concavity row line 328 may be generally parallel to the center axis 130 of the one-piece can combustor 102. According to other example embodiments of the invention, the concavity row line 328 may form any angle between about 0 and about 45 degrees with respect to the center axis 130 of the one-piece can combustor 102.

FIG. 3D depicts another example surface feature 202 comprising an array of grooves 330 cast within the one-piece can combustor 102 according to another embodiment of the invention. In this embodiment, the grooves 330 may have a circular depth profile with a radius of curvature ranging from about 1 to about 3 mm. The grooves may define a groove width 332 ranging from about 2 to about 8 mm, and a groove spacing 334 ranging from about 5 to about 13 mm. According to an example embodiment of the invention, the groove center line 336 may be generally parallel to the center axis 130 of the one-piece can combustor 102. According to other example embodiments of the invention, the groove center line 336 may form any angle between about 0 and about 45 degrees with respect to the center axis 130 of the one-piece can combustor 102.

FIG. 3E depicts another example surface feature 202 comprising an array of fins 340 cast within the one-piece can combustor 102 according to another embodiment of the invention. The fins 340 may be about 0.5 to about 3 mm in height, and may have either a substantially flat or rounded fin top 342 surface. The fins 340 may also transition from the flat, lower regions, to the fin top 342 with a transition radius approximately 0.1 mm. The width 344 of the fins may be approximately 1 to approximately 7 mm, and the length 346 may be approximately 1 to approximately 7 mm. The fin row spacing 348 may be approximately 2 to approximately 8 mm, and the fin column spacing 350 may be approximately 2 to approximately 8 mm. The fins 340 may be defined with an alternating column offset 352 approximately 0 to approximately 5 mm. The fin row line 354 may be generally parallel to the center axis 130 of the one-piece can combustor 102. According to other example embodiments of the invention, the fin row line 354 may form any angle between about 0 and about 90 degrees with respect to the center axis 130 of the one-piece can combustor 102. Since the diameter of the one-piece can combustor varies from the head end 104 to the aft end 108, it will be appreciated that the fin length 346, the fin row spacing 348, and/or the fin column spacing 350 may vary as a function of the position along the body of the one-piece can combustor 102.

FIG. 3F depicts another example surface feature 202 comprising an array of curved dunes 360 cast within the one-piece can combustor 102 according to another embodiment of the invention. The dunes 360 may generally have sand dune-type shape, ranging from about 0.5 to about 3 mm in height, and may have a substantially rounded top surface 362 having a top surface radius ranging from about 3 to about 7 mm. The dunes 360 may be further defined by a solid cylindrical cutout 366 on one side of the curved dune 360, with a cutout angle approximately 45 degrees with respect to the line normal to the surface, and with a diameter of the cutout approximately one-half the diameter 368 of the dune 360. The diameter 368 of the dune 360 may be approximately 7 to approximately 13 mm. The dune row period 370 may be approximately 11 to approximately 20 mm, and the dune column period 372 may be approximately 11 to approximately 20 mm. The dune row line 374 may be generally parallel to the center axis 130 of the one-piece can combustor 102. According to other example embodiments of the invention, the dune row line 374 may form any angle between about 0 and about 45 degrees with respect to the center axis 130 of the one-piece can combustor 102. According to an example embodiment of the invention, the curved dunes 360 may be defined so that the cutout portions 364 are positioned towards the head end 104. According to other example embodiments, the curved dunes 360 may be defined so that the cutout portions 364 are distributed substantially downwind with respect to direction of the discharge airflow 112 at each local surface feature. Furthermore, since the diameter of the one-piece can combustor 102 varies from the head end 104 to the aft end 108, it will be appreciated that the dune diameter 368, row spacing 370, and/or column spacing 372 may vary as a function of the position along the body of the one-piece can combustor 102.

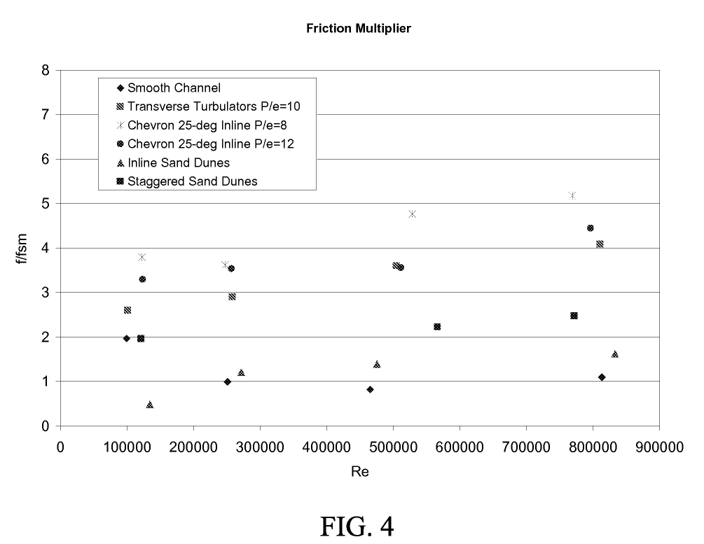

FIG. 4 depicts measured friction multiplier data for several example surface enhancement embodiments, according to example embodiments of the invention. The variable ‘f’ represents the coefficient of friction, sometimes called the friction factor, for any particular surface. The variable ‘fsm’ represents the coefficient of friction for a smooth surface without augmentation features or roughness. The ratio ‘f/fsm’ represents the augmentation of the coefficient of friction for a non-smooth surface, sometimes called the friction multiplier. ‘Re’ represents the Reynolds number of the backside convective flow, defined as the product of fluid bulk velocity times the characteristic length of the geometry, divided by the kinematic viscosity of the fluid. For example, FIG. 4 shows comparison data for a smooth surface (without surface enhancements), transverse turbulators (continuous turbulator rib, for example, with no rib end separation 310 and with angle 312 approximately 90 degrees), chevron patterns (as shown in FIG. 3B, with the angle 312 approximately 65 degrees), staggered sand dunes (as shown in FIG. 3F) and in-line sand dunes (not shown). The variable “P” in FIG. 4 represents the “pitch” between the ribs, or the rib row separation 308. The variable “e” represents the rib height. Since the friction multiplier may correspond with a pressure drop in the airflow, the selection of a particular surface feature embodiment is typically based upon a trade-off between minimizing the friction while maximizing the heat removal efficiency.

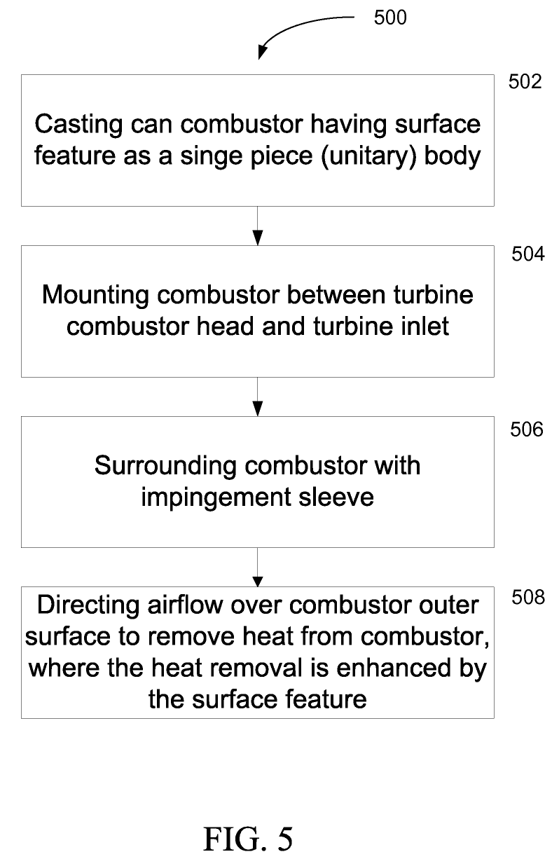

An example method will now be described with reference to the flowchart of FIG. 5 in accordance with an embodiment of the invention. Beginning in block 502, a one-piece can combustor such as 102 may be cast with surface features as a one-piece, unitary body. A method for manufacturing a one-piece can combustor such as 102, according to example embodiments of the invention, may include using expendable or non-expendable mold casting, die casting, semi-solid metal casting, centrifugal casting, continuous casting, etc. According to certain example embodiments, various materials used in manufacturing a one-piece can combustor such as 102 may include high temperature alloys such as Udimet 500, Haynes 188, or Haynes 230 for example.

Block 502 is followed by block 504, in which the one-piece can combustor, such as 102, may be mounted between a turbine combustor head end, such as 104, and an aft end, such as 108. As shown in FIGS. 1 and 2, an aft frame such as 122, including a sealing surface and mounting features 204, may be cast as part of the single piece can combustor 102, and the mounting features 204 may be designed to be secured to one more mounting brackets 126 attached to the frame of the turbine. The cap seal interface 128 at the head end 104 of the one-piece can combustor 102 may be mounted to the turbine using radial struts 124, for example.

Block 504 is followed by block 506, in which the one-piece can combustor such as 102 may be surrounded by an impingement sleeve such as 114 to provide passage paths for discharge air such as 112 from the compressor to the surface of the one-piece can combustor 102, and to define a cooling annulus such as 116 around the one-piece can combustor 102 for directing air towards the head end such as 104 where it can be mixed with fuel in the plurality of fuel nozzles such as 106.

Block 506 is followed by block 508, in which the discharge air flowing within the cooling annulus such as 116 may interact with the surface of the one-piece can combustor such as 102, thereby removing heat from the one-piece can combustor 102. The heat removal process may be enhanced via the local interaction of the discharge air 112 with the surface features 202.

It may be appreciated in the foregoing description of the method 500 of FIG. 5 that a cast, one-piece can combustor such as 102 with one or more cast surface enhancements such as 202, according to certain embodiments, may provide an advantage over conventional multiple-piece combustors. In such embodiments, the minimization of the number of pieces can reduce the assembly time, reduce the number of seals required in connecting the combustor to the head end and aft end of the turbine, and eliminate or otherwise reduce the extra machining that would otherwise be required to define the surface features 202. At least one technical effect of at least one embodiment of the invention is that heat from the can combustor body may be transferred through the at least one surface feature to the air flow.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

We claim:

1. A method for transferring heat from a can combustor associated with a gas turbine, the method comprising:
providing a one-piece can combustor body comprising at least one surface feature operable to transfer heat away from the can combustor body; and
directing air flow adjacent to the at least one surface feature, wherein heat from the can combustor body is transferred through the at least one surface feature to the air flow.

2. The method of claim 1, further comprising:
mounting the can combustor body in a gas turbine between an associated combustor head end and turbine inlet.

3. The method of claim 1, wherein the at least one surface feature comprises at least one of: a raised section above the surface of the can combustor body, a depressed section below the surface of the can combustor body, a circular-shaped dimple, a circular shaped bump, a raised rectangular-shaped fin, a chevron-shaped feature, a sand dune-shaped feature, a trough, and a ridge.

4. The method of claim 1, wherein directing air flow adjacent to the at least one surface feature comprises directing air flow using an impingement sleeve, wherein the impingement sleeve comprises a plurality of cooling apertures for directing air into an associated flow annulus adjacent to the can combustor body.

5. The method of claim 1, wherein the can combustor body and at least one surface feature are cast as a unitary component.

6. The method of claim 1, wherein the at least one surface feature is either mounted to or machined into the can combustor body.

7. The method of claim 1, wherein the at least one surface feature is associated with an exterior surface of the can combustor body.

8. A system for transferring heat from a can combustor associated with a gas turbine, the system comprising:
a one-piece can combustor body comprising at least one surface feature operable to transfer heat away from the can combustor body; and
a sleeve for directing air flow adjacent to the at least one surface feature, wherein heat from the can combustor body is transferred through the at least one surface feature to the air flow.

9. The system of claim 8, wherein the can combustor body is mounted in a gas turbine between an associated combustor head end and turbine inlet.

10. The system of claim 8, wherein the at least one surface feature comprises at least one of: a raised section above the surface of the can combustor body, a depressed section below the surface of the can combustor body, a circular-shaped dimple, a circular shaped bump, a raised rectangular-shaped fin, a chevron-shaped feature, a sand dune-shaped feature, a trough, and a ridge.

11. The system of claim 8, wherein directing air flow adjacent to the at least one surface feature comprises directing air flow using an impingement sleeve, wherein the impingement sleeve comprises a plurality of cooling apertures for directing air into an associated flow annulus adjacent to the can combustor body.

12. The system of claim 8, wherein the can combustor body and at least one surface feature are cast as a unitary component.

13. The system of claim 8, wherein the at least one surface feature is either mounted to or machined into the can combustor body.

14. The system of claim 8, wherein the at least one surface feature is associated with an exterior surface of the can combustor body.

15. An apparatus for dissipating heat from a can combustor associated with a gas turbine, the apparatus comprising:
a surface of a one-piece can combustor body;
at least one surface feature associated with the surface of the one-piece can combustor body, wherein the at least one surface feature is operable to transfer heat away from the can combustor body when an air flow is directed adjacent to the at least one surface feature.

16. The apparatus of claim 15, wherein the can combustor body is mounted in a gas turbine between an associated combustor head end and turbine inlet.

17. The apparatus of claim 15, wherein the at least one surface feature comprises at least one of: a raised section above the surface of the can combustor body, a depressed section below the surface of the can combustor body, a circular-shaped dimple, a circular shaped bump, a raised rectangular-shaped fin, a chevron-shaped feature, a sand dune-shaped feature, a trough, and a ridge.

18. The apparatus of claim 15, wherein directing air flow adjacent to the at least one surface feature comprises directing air flow using an impingement sleeve, wherein the impingement sleeve comprises a plurality of cooling apertures for directing air into an associated flow annulus adjacent to the can combustor body.

19. The apparatus of claim 15, wherein the can combustor body and at least one surface feature are cast as a unitary component.

20. The apparatus of claim 15, wherein the at least one surface feature is either mounted to or machined into the can combustor body.
